(19) United States
(12) Patent Application Publication
(10) Pub. No.: US 2020/0015408 A1
(43) Pub. Date: Jan. 16, 2020

(54) Autonomously Operated Agricultural Vehicle and Method

(71) Applicant: Alan Dean Armstead, Ozawkie, KS (US)

(72) Inventor: Alan Dean Armstead, Ozawkie, KS (US)

(21) Appl. No.: 16/450,491

(22) Filed: Jun. 24, 2019

Related U.S. Application Data
(60) Provisional application No. 62/698,849, filed on Jul. 16, 2018.

(51) Int. Cl. A01B 69/04; G05D 1/02; A01B 35/32; A01B 39/20; A01C 23/04

(52) U.S. Cl. CPC A01B 69/008; G05D 1/0231; G06T 7/70; A01B 39/20; A01C 23/047; A01B 35/32

(57) ABSTRACT

A method for autonomously performing an agricultural operation includes automatically moving a vehicle having at least one agricultural operation device to a starting location for the agricultural operation. An indicator for the starting location is optically identified. A position of the vehicle to a selected distance from the indicator is automatically adjusted. The agricultural operation device is automatically operated. The vehicle is automatically moved along a selected trajectory and the automatically operating the at least one agricultural operation device is repeated until a predetermined number of automatic operations of the agricultural operation device have been performed.

### CROSS REFERENCE TO RELATED APPLICATIONS

Priority is claimed from U.S. Provisional Application No. 62/698,849 filed on Jul. 16, 2018 and incorporated herein by reference in its entirety.

### BACKGROUND

This disclosure relates to the field of agricultural apparatus for performing certain operations on agricultural crops, for example, dispensing spray products. More specifically, the disclosure relates to apparatus for autonomously performing selected operations on or treatments to crops.

Weeds and grass need to be well controlled near and around agricultural crops such as grapevines. Fungicides may need to be sprayed on crops such as grapevines multiple times per growing season. It is known in the art for weed control to apply herbicides by spraying along a large strip along every crop row manually, either from a small vehicle having a chemical tank or using a backpack type sprayer operated by an individual while walking. It is time consuming to spray herbicides multiple times per year using such methods. Additionally, some crops may need different spray patterns and/or amounts of herbicide in respective treatments. First and second year vines, for example may need wide application strips. More mature crops or vines may need a smaller kill zone or even a no kill zone, depending on crop vigor and root establishment. It is known in the art that applying fungicides may require spraying vines using a small vehicle having a tank, using a tractor and air blast sprayer, or by backpack type sprayer carried by a walking individual. Treatments are typically needed multiple times per year. Usually a different type of fungicide is applied at each treatment.

### SUMMARY

An autonomous sprayer vehicle according to the present disclosure is adapted to spray a desired pattern of herbicide such as small ring around individual plants in crops, or strips of varying width. The sprayer vehicle will also have a vertical spray boom for precision spraying of vines. In each instance, individual nozzles can be turned off/on based on need. Spraying is controlled and performed using a combination of displacement sensors, optical sensors and image analysis, and machine learning.

A method for autonomously performing an agricultural operation according to one aspect of the present disclosure comprises automatically moving a vehicle having at least one agricultural operation device to a starting location for the agricultural operation; automatically optically identifying an indicator for the starting location; automatically adjusting position of the vehicle to a selected distance from the indicator; automatically operating the at least one agricultural operation device; and automatically moving the vehicle along a selected trajectory and repeating the automatically operating the at least one agricultural operation device until a predetermined number of automatic operations of the at least one agricultural operation device have been performed.

In some embodiments, the automatically moving to the starting location comprises determining geodetic location of the vehicle with reference to a geodetic location of the indicator.

In some embodiments, the determining geodetic location of the vehicle comprises detecting position signals from a satellite.

In some embodiments, the moving along the selected trajectory comprises measuring a geomagnetic direction.

In some embodiments, the automatically optically identifying comprises obtaining an optical image of the indicator and comparing the optical image to at least one of a user provided optical description and optical image data communicated to the vehicle.

In some embodiments, the at least one agricultural operation comprises spraying a liquid onto a plant.

Some embodiments further comprise wirelessly communicating to the vehicle at least one of the starting location and the predetermined number of automatic operations.

### BRIEF DESCRIPTION OF THE DRAWINGS

FIGS. 1 through 5 show various components of an example embodiment of an autonomous agricultural vehicle according to the present disclosure

FIG. 6 shows a flow chart of a process implemented on a vehicle such as shown in FIGS. 1 through 5.

### DETAILED DESCRIPTION

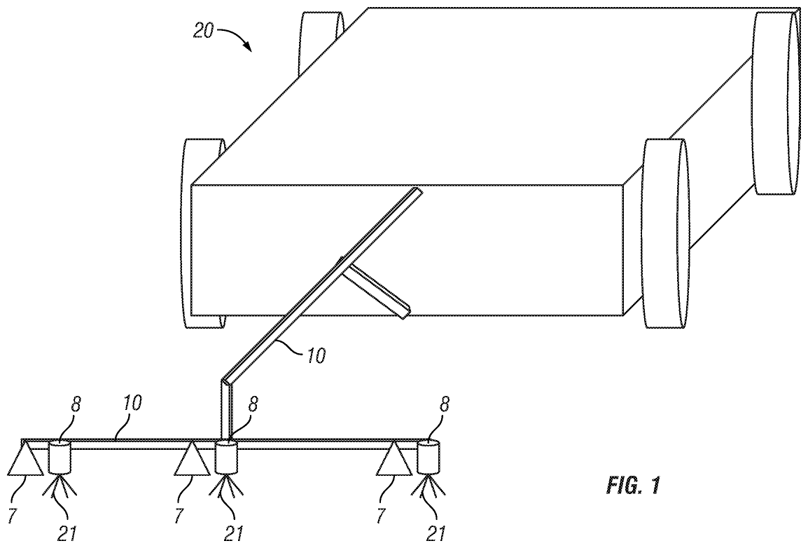

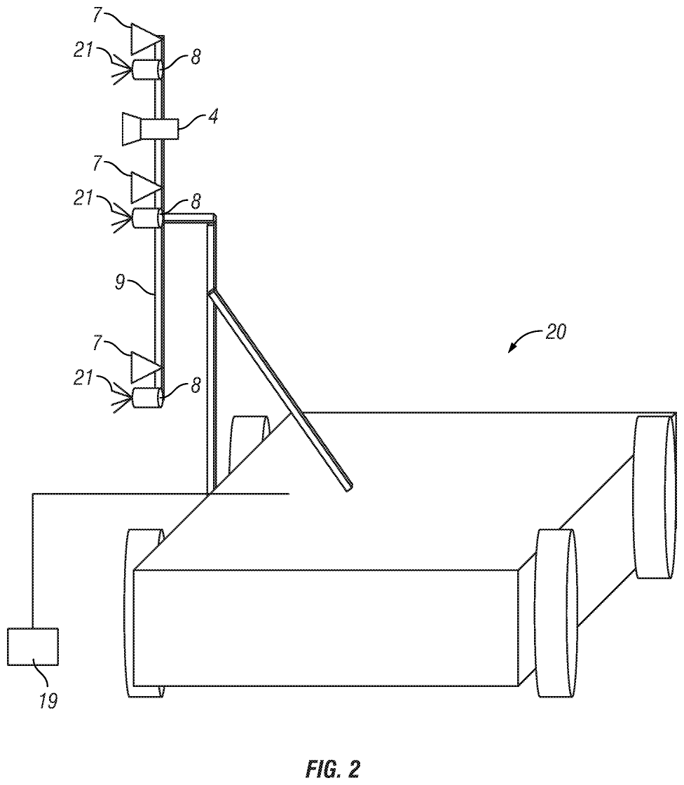

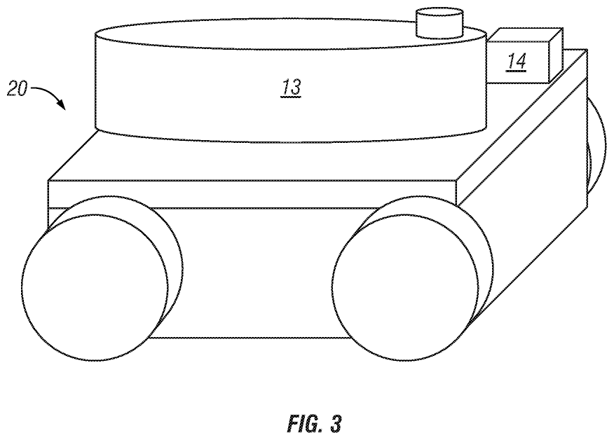

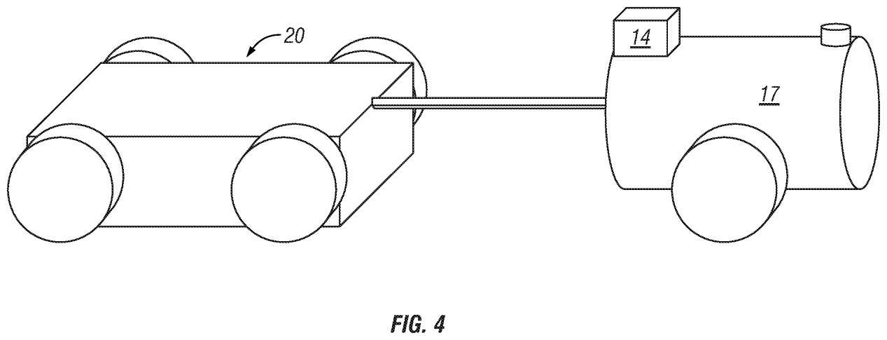

An example embodiment of an autonomous agricultural vehicle 20 according to the present disclosure may be understood with reference to FIGS. 1 through 5. An embedded controller 1, for example one sold under the trademark MYRIO by National Instruments, Austin, TX may be attached to the vehicle 20. The controller 1 may be any device that runs embedded or acquired software and contains and/or communicates with necessary electronic hardware input/output devices (e.g., drivers or power amplifiers) to communicate with and operate peripherals, acquire signals from cameras and other sensors, and control motors, pumps and actuators.

The software or instructions that run on the controller 1 may cause one or more of the following processes and process elements to take place:

Signal acquisition: The controller 1 may acquire signals from sensors, such as range sensors 7 (e.g., acoustic or radar range sensors), cameras 4 (e.g., charge coupled devices), magnetometers 5, accelerometers (e.g., embedded in the controller 1 or provided separately), geodetic position signal sensors such as global positioning satellite (GPS) or global navigation satellite system (GNSS) signal receivers and the like.

Control: Operating signals to drive motors 3, pumps, and/or actuators may be generated by the controller 1.

Navigation: Using geodetic position (e.g., GPS or GNSS) or similar signals, magnetometer signals, optical (simulated vision) signal acquisition and optical signal processing, and machine learning, the controller 1 may be provided enough information by the user and from such signals to position the vehicle 20 to within a selected distance of an object of interest. Simulated vision, e.g., optical identification, may be used to identify the object of interest and to determine the vehicle's 20 and the object's geodetic location. When after optical identification the controller 1 has determined the object's geodetic location, the controller 1 may store an image of the object of interest for subsequent use and operation of the vehicle 20. Any subsequent time the controller 1 is programmed or operated to find the object of interest, e.g., for subsequent treatment of a crop, the controller 1 may recall the previously stored image of the object of interest and use pattern matching or other optical recognition process to assist in locating the same object of interest.

Targeted spraying: The controller 1 may be programmed to turn on and off individual sprayers based on geodetic location and other information such as optical pattern recognition.

A battery 12 may be provided to power the embedded controller 1, sensors, motors, etc. Drive motors 3 may be arranged to drive wheels that will move the autonomous vehicle 20. A camera 4, e.g., a charge coupled device, may acquire optical signals for processing as explained with reference to the controller 1. Magnetometers 5 may acquire geomagnetic (compass heading) signals. Such signals, along with signals acquired from a triaxial accelerometer (e.g., embedded in the controller 1) may be combined by the controller 1 to provide vehicle geodetic or geomagnetic heading. A power distribution system 6 may provide stepped down voltage and current protection (fuses). Range sensors 7 such as radar or acoustic range sensors may be provided to measure distance between the vehicle 20 and any selected object. Spray nozzles 21 may be individually controllable by a suitable signal from the controller 1. In some embodiments, the spray nozzles 21 may be controlled by solenoid operated valves 8, wherein a liquid supply line (not shown separately) to each spray nozzle 21 remains pressurized at all times, and wherein spraying is performed by selectively operating each respective solenoid valve 8. A vertical boom 9 having thereon one or more range sensors 7 and spray nozzles 21 may be used for spraying vines, plants, etc. A horizontal boom 10 having thereon one or more range sensors 7 and spray nozzles 21 may be provided for spraying on the ground.

A cellular communications router 11 may be provided for communicating between the controller 1 and a central server 12. The central server 12 may be cloud-based and may communicate with the autonomous vehicle 20 to schedule tasks. The vehicle 20 may, from the controller 1, communicate status, machine health, and sensor data to the central server 12. Sensor data may include optical images that can be used for navigation.

One or more small tanks 13, e.g., small enough to be mounted on the autonomous vehicle 20, may be used for jobs requiring smaller amounts of spray as needed and/or precision navigation/spraying. The small tanks 13 may be, for example, 10 to 40 gallons each. An example of precision navigation/spraying may comprise spraying a small ring of herbicide around the circumference of one or more plants or (fence or utility) posts. Targeted spraying may be performed, for example, using insecticide only on detection or identification of insect pests.

One or more pumps 14 may be provided on the vehicle 1 to pump liquid out of the tanks (e.g., at 13) to the booms (9, 10) and spray nozzles 21.

Some embodiments may comprise a large tank 17, such as a pull behind tank, e.g., having capacity in the range of, e.g., 40 to 100 gallons. Used for spraying larger quantities, and or when large strips/swaths of spray is necessary. For example, spraying grapevine foliage with the vertical boom may require the use of the large tank 17.

Some embodiments may comprise a sensor probe 19 comprising one or more of a soil moisture sensor, a range finder oriented vertically, a temperature sensor, a camera, and a sugar content sensor (none shown separately). Such sensor(s) may be used in some embodiments to collect data concerning soil moisture, canopy height, thickness and bud/cluster content and fruit sugar content.

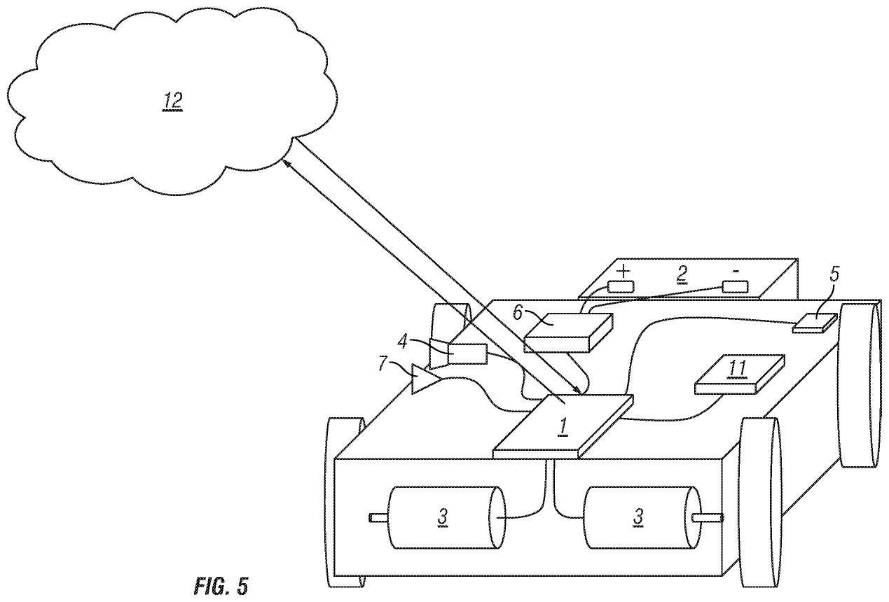

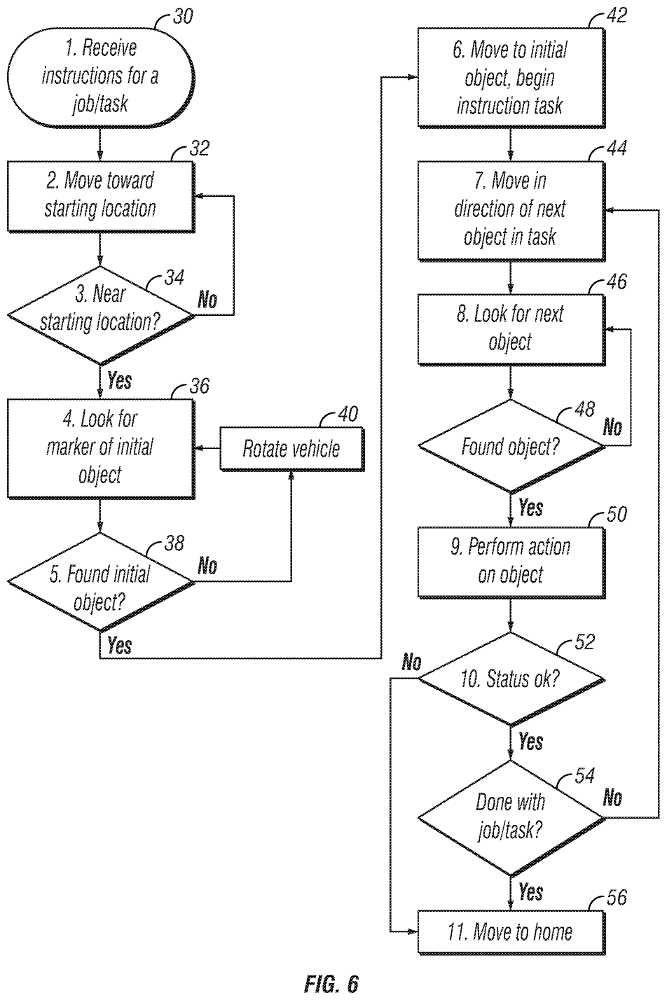

Having explained embodiments of an autonomous vehicle, processes according to the present disclosure will now be explained. FIG. 6 shows a flow chart of an example process that may be performed by the autonomous vehicle (20 in FIG. 1). At 30, the autonomous vehicle (20 in FIG. 1) may receive instructions from, e.g., a central server, such as by IEEE 802.11 wireless communication protocol (WiFi), cellular wireless communication, wireless communication such as BLUETOOTH protocol, etc. to perform a job. BLUETOOTH is a registered trademark of Bluetooth Special Interest Group, Inc. Kirkland, WA. The central server is shown schematically at 12 in FIG. 5.

A job may comprise spraying, mowing, tilling, inspecting, deterring pests, etc.

The instructions may comprise top-level information about the job, for example, where to start defined by geodetic location and/or optical recognition of an object of interest, how many crop rows to operate on, how long the rows are and in what geodetic orientation (north/south, east/west, etc.), how to identify the rows optically or otherwise and how many plants/posts are in each row. In some embodiments, soil moisture levels, temperatures, canopy thickness, bud/cluster count, fruit sugar content, etc.

At 32, the motors/wheels (3 in FIG. 5) are operated under command of the controller (1 in FIG. 5) to move the vehicle (20 in FIG. 1) in the direction of the starting location, using, for example, signals from a GPS signal receiver (may be part of the controller 1 in FIG. 5).

At 34, the controller 1 may compare the vehicle geodetic location to the geodetic location of a predetermined starting point of the job to determine if the vehicle geodetic location is within a predetermined distance of the starting point. If the vehicle is not within such predetermined distance, vehicle motion continues in the geodetic or geomagnetic direction of the starting point. If the vehicle is within the selected distance, at 36, the controller activates the camera (4 in FIG. 5) to search for a marker (i.e., the object of interest) corresponding to the starting point. If the marker is not optically identified, the controller may instruct the vehicle to rotate at 40. Once the marker is optically identified, vehicle rotation may stop and at 42, the controller may cause vehicle to move in the geodetic or geomagnetic direction of the marker.

The marker may be, for example, the number “1” on a sign on a post, a QR code, a name plate or another symbol. The marker may be matched against marker optical characterization data sent with the original instructions, or the maker data could be matched against a database of known objects, such as the number “1”, another symbol or text information embedded in a QR code.

Once the vehicle is disposed proximate the starting point, the controller may cause the vehicle to begin the job, e.g., by turning on sprayers, mower, tiller, thermal camera, etc. The vehicle may be moved along a selected direction, for example, guided by signals from the magnetometer (5 in FIG. 5) as well as by optical signals from the camera (4 in FIG. 5).

The controller causes operation of the motors to move the vehicle in the direction of the next indicator at 46 for the specific job. The next indicator direction could be determined by tilt-compensated digital compass (magnetometer), GPS signals, etc. The vehicle is caused to move a distance indicated by instructions to be a selected distance from the next indicator, for example, about 6 feet, so the vehicle may be caused to move 5.5 feet.

Before the vehicle is caused to move the full distance to the next indicator, at 48, the next indicator may be searched optically. Optical searching may comprise acquiring optical signals and using machine learning, pattern matching, edge detection, color comparison, or the like to determine existence of the indicator in the image. The next indicator image data may be recalled from local memory, such as in the controller, or may be communicated to the vehicle from the central server (12 in FIG. 5). The next indicator may have been initially discovered by image analysis performed on the vehicle (e.g., by the controller 1 in FIG. 5) in a “learning mode” or by user input such as by describing the next indicator or manually selecting it from a visual display of the image. If the next indicator is not identified in the image, at 46, the vehicle may be moved and/or rotated and a second image taken. The second image may be processed to identify the next indicator.

When the next indicator is identified, at 50, the controller may instruct the vehicle to perform any selected action or actions on the crops associated with the next indicator. The actions may comprise, for example, spraying/mowing/tilling around the outside of a selected object (e.g., a post, a tree, grapevine), and/or acquiring optical images of a plant for inspection, or taking thermal images looking for pests, etc.

At 52, if at any time, the status of the vehicle or the ambient environment indicates that the job or task should be stopped or temporarily paused, the vehicle may be instructed to return to a home base or other deployment point. Causes to stop a job and return the vehicle to its deployment point may include, for example, low battery power excessively windy conditions as may permit spraying, onset of rain, a user request, etc.

The instructions communicated to or stored on the vehicle may describe how many indicators are to be identified in each crop row for any job having a plurality of crop rows. When the last indicator in a row has been identified, the instructions for the vehicle may provide for the next task to move the vehicle to the next crop row in the job. Included in the instructions may be the relative location of each subsequent row in the job. If, for example, the rows extend north/south, and are spaced 10 feet apart, and the vehicle starts a job at the east-most row, then after completion of the first row, the vehicle will move west 10 feet and begin optical scanning for an identifier for the second row. In some embodiments, the next (e.g., second) row may be identified by locating another row marker such as a posted number, QR code, or the like, or by the same type of image analysis/machine learning as is done when finding the “next identifier.” If the rows are marked with QR codes or some other type of identifier that allows for embedding information, such identifier could contain all of the necessary information about that particular row, for example and without limitation, how many plants/posts in the row, length of the row, type of plants, etc. In the foregoing embodiment, instructions from the central server may contain less of the detailed information about the specifics of the physical layout, and more detailed information may be acquired dynamically from the indicator on each row as the job is being performed.

When a task/job is complete at 54, the controller may operate the vehicle to return at 56 to its ‘home’ location, at which point the battery may be recharged.

Novelty of methods and systems according to the present disclosure may reside in the use of optical element recognition (vision) and machine learning for navigation. Systems and methods known in the art prior to the present disclosure rely on geodetic positioning or LIDAR to navigate by fixed reference, while systems and methods according to the disclosure may be programmed to recognize optically distinct features as navigation references.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A method for autonomously performing an agricultural operation, comprising:
automatically moving a vehicle having at least one agricultural operation device to a starting location for the agricultural operation;
automatically optically identifying an indicator for the starting location;
automatically adjusting position of the vehicle to a selected distance from the indicator;
automatically operating the at least one agricultural operation device; and
automatically moving the vehicle along a selected trajectory and repeating the automatically operating the at least one agricultural operation device until a predetermined number of automatic operations of the at least one agricultural operation device have been performed.

2. The method of claim 1 wherein the automatically moving to the starting location comprises determining geodetic location of the vehicle with reference to a geodetic location of the indicator.

3. The method of claim 2 wherein the determining geodetic location of the vehicle comprises detecting geodetic position signals from a satellite.

4. The method of claim 1 wherein the moving along the selected trajectory comprises measuring a geomagnetic direction.

5. The method of claim 1 wherein the automatically optically identifying comprises obtaining an optical image of the indicator and comparing the optical image to at least one of a user provided optical description and optical image data communicated to the vehicle.

6. The method of claim 1 wherein the at least one agricultural operation comprises spraying a liquid onto a plant.

7. The method of claim 1 further comprising wirelessly communicating to the vehicle at least one of the starting location and the predetermined number of automatic operations.
